(19) United States
(12) Patent Application Publication
(10) Pub. No.: US 2004/0177198 A1
(43) Pub. Date: Sep. 9, 2004

(54) High speed multiple ported bus interface expander control system

(75) Inventors: Anthony Joseph Benson, Roseville, CA (US); Thin Nguyen, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX

(21) Appl. No.: 10/370,361

(22) Filed: Feb. 18, 2003

(51) Int. Cl. G06F 13/00

(52) U.S. Cl. 710/301

(57) ABSTRACT

An expander controller for a dual ported bus interface comprises a controller coupled to the dual ported bus interface. The dual ported bus interface has first and second front end ports capable of connecting to host bus adapters, and first and second isolator/expanders coupled to the first and second front end ports. The bus interface also has first and second backplane connectors for insertion into a selected slot of first and second slots and coupling to one or more buses on the backplane. The bus interface further includes interconnections for coupling signals from the first and second front end ports through the isolator/expanders to the backplane buses. The expander controller further includes a programmable code executable on the controller and further comprising a programmable code that detects interface status, bus configuration, and selected slot; and a programmable code that controls operations of the isolator/expanders based on the detected interface status, bus configuration, and selected slot.

### RELATED APPLICATIONS

The disclosed system and operating method are related to subject matter disclosed in the following co-pending patent applications that are incorporated by reference herein in their entirety: (1) U.S. patent application Ser. No. ______, entitled “High Speed Multiple Port Data Bus Interface Architecture;” (2) U.S. patent application Ser. No. ______, entitled “High Speed Multiple Ported Bus Interface Control;” (3) U.S. patent application Ser. No. ______, entitled “High Speed Multiple Ported Bus Interface Port State Identification System;” (4) U.S. patent application Ser. No. ______, entitled “System and Method to Monitor Connections to a Device;” (5) U.S. patent application Ser. No. ______, entitled “High Speed Multiple Ported Bus Interface Reset Control System;” and (6) U.S. patent application Ser. No. ______, entitled “Interface Connector that Enables Detection of Cable Connection.”

### BACKGROUND OF THE INVENTION

A computing system may use an interface to connect to one or more peripheral devices, such as data storage devices, printers, and scanners. The interface typically includes a data communication bus that attaches and allows orderly communication among the devices and the computing system. A system may include one or more communication buses. In many systems a logic chip, known as a bus controller, monitors and manages data transmission between the computing system and the peripheral devices by prioritizing the order and the manner of device control and access to the communication buses. Control rules, also known as communication protocols, are imposed to promote the communication of information between computing systems and peripheral devices. For example, Small Computer System Interface or SCSI (pronounced “scuzzy”) is an interface, widely used in computing systems, such as desktop and mainframe computers, that enables connection of multiple peripheral devices to a computing system.

In a desktop computer SCSI enables peripheral devices, such as scanners, CDs, DVDs, and Zip drives, as well as hard drives to be added to one SCSI cable chain. In network servers SCSI connects multiple hard drives in a fault-tolerant cluster configuration in which failure of one drive can be remedied by replacement from the SCSI bus without loss of data while the system remains operational. A fault-tolerant communication system detects faults, such as power interruption or removal or insertion of peripherals, allowing reset of appropriate system components to retransmit any lost data.

A SCSI communication bus follows the SCSI communication protocol, generally implemented using a 50 conductor flat ribbon or round bundle cable of characteristic impedance of 100 Ohm. SCSI communication bus includes a bus controller on a single expansion board that plugs into the host computing system. The expansion board is called a Bus Controller Card (BCC), SCSI host adapter, or SCSI controller card.

In some embodiments, single SCSI host adapters are available with two controllers that support up to 30 peripherals. SCSI host adapters can connect to an enclosure housing multiple devices. In mid to high-end markets, the enclosure may have multiple controller interface or controller cards forming connection paths from the host adapter to SCSI buses resident in the enclosure. Controller cards can also supply bus isolation, configuration, addressing, bus reset, and fault detection operations for the enclosure.

One or more controller cards may be inserted or removed from the backplane while data communication is in process, a characteristic termed “hot plugging.”

Single-ended and high voltage differential (HVD) SCSI interfaces have known performance trade-offs. Single ended SCSI devices are less expensive to manufacture. Differential SCSI devices communicate over longer cables and are less susceptible to external noise influences. HVD SCSI is more expensive. Differential (HVD) systems use 64 milliamp drivers that draw too much current to enable driving the bus with a single chip. Single ended SCSI uses 48 milliamp drivers, allowing single chip implementations. High cost and low availability of differential SCSI devices has created a market for devices that convert single ended SCSI to differential SCSI so that both device types coexist on the same bus. Differential SCSI in combination with a single ended alternative is inherently incompatible and has reached limits of physical reliability in transfer rates, although flexibility of the SCSI protocol allows much faster communication implementations.

### SUMMARY OF THE INVENTION

In accordance with some embodiments of the illustrative system, an expander controller for a dual ported bus interface comprises a controller coupled to the dual ported bus interface. The dual ported bus interface has first and second front end ports capable of connecting to host bus adapters, and first and second isolator/expanders coupled to the first and second front end ports. The bus interface also has first and second backplane connectors for insertion into a selected slot of first and second slots and coupling to one or more buses on the backplane. The bus interface further includes interconnections for coupling signals from the first and second front end ports through the isolator/expanders to the backplane buses. The expander controller further includes a programmable code executable on the controller and further comprising a programmable code that detects interface status, bus configuration, and selected slot; and a programmable code that controls operations of the isolator/expanders based on the detected interface status, bus configuration, and selected slot.

In accordance with other embodiments, a dual ported bus interface comprises first and second front end ports capable of connecting to host bus adapters, and first and second isolator/expanders coupled to the first and second front end ports. The bus interface further comprises first and second backplane connectors for insertion into a selected slot of first and second slots and coupling to one or more buses on the backplane. The bus interface further comprises a controller coupled to the first and second isolator/expanders for communicating signals from the first and second front end ports through the isolator/expanders to the backplane buses with bridging. The controller is capable of detecting interface status, bus configuration, and selected slot, and capable of controlling operations of the isolator/expanders based on the detected interface status, bus configuration, and selected slot.

In accordance with further embodiments, a method of controlling operations of isolator/expanders in a dual ported bus interface comprises detecting status of the bus interface from among a primary state, a secondary state, a pseudo state, and a fault state. The method further comprises determining a configuration of the bus interface between a full bus configuration and a split bus configuration, and determining a slot into which the bus interface is inserted from between a first slot and a second slot. The method also comprises controlling operations of the isolator/expanders based on the detected interface status, the bus configuration, and the selected slot.

### BRIEF DESCRIPTION OF THE DRAWINGS

Embodiments of the invention relating to both structure and method of operation, may best be understood by referring to the following description and accompanying drawings.

FIG. 1 is a schematic block diagram that illustrates an embodiment of a bus architecture.

FIG. 2 is a schematic block diagram showing an example of a communication system with a data path architecture between one or more bus controller cards, peripheral devices, and host computers including, respectively, a system view, component interconnections, and monitor elements.

### DETAILED DESCRIPTION

To address deficiencies and incompatibilities inherent in the physical SCSI interface, Low Voltage Differential SCSI (LVD) has been developed. Twenty-four milliamp LVD drivers can easily be implemented within a single chip, and use the low cost elements of single ended interfaces. LVD can drive the bus reliably over distances comparable to differential SCSI. LVD supports communications at faster data rates, enabling SCSI to continue to increase speed without changing from the LVD physical interface.

A SCSI expander is a device that enables a user to expand SCSI bus capabilities. A user can combine single-ended and differential interfaces using an expander/converter, extend cable lengths to greater distances via an expander/extender, isolate bus segments via an expander/isolator. A user can increase the number of peripherals the system can access, and/or dynamically reconfigure SCSI components. For example, systems based on HVD SCSI can use differential expander/converters to allow a system to access a LVD driver in the manner of a HVD driver.

What is desired in a bus interface that supports high speed signal transmission using LVD drivers is a capability to control expanders to avoid SCSI bus contention and possible data corruption. What is further desired is a capability to determine enclosure configuration without requiring monitoring of interface configuration across the backplane.

The bus architecture can be configured to include a controller for controlling expanders in a dual port bus interface. Functional elements in the interface, for example electronic hardware and programming elements, perform various control tasks. In a particular example, the electronic hardware can comprise various electronic circuit devices such as field programmable gate arrays (FPGAs), programmable logic devices (PLDs), or other control or monitoring devices, and the programming elements can comprise executable firmware code. The monitor accesses various signals to define and identify port state.

Accordingly, control elements, such as a field programmable gate array (FPGA) can determine how the enclosure is configured and can use the information to determine how long to hold SCSI bus resets.

In a specific embodiment, the controller can operate in a dual port bus interface card or bus controller card (BCC). The interface can couple to one or more host computers via a front end and can couple to a backplane of a data bus via a back end. At the back end, terminators can be connected to backplane connectors to signal the terminal end of the data bus. Proper functionality of the terminators depends on supply of sufficient “term power” from the data bus, typically supplied by a host adapter or other devices on the data bus. The dual port system accordingly can include two interfaces or BCCs. Each interface can perform monitoring operations in conjunction with operations of the second interface, called the peer interface or peer card. The dual interfaces can each have a controller that executes instructions to monitor conditions, control the interface, communicate status information and data to host computers via a data bus, such as a SCSI bus, and can also support diagnostic procedures for various components of system. Each interface can also include one or more bus expanders that allow a user to expand the bus capabilities. For example, an expander can mix single-ended and differential interfaces, extend cable lengths, isolate bus segments, increase the number of peripherals the system can access, and/or dynamically reconfigure bus components. The dual port bus interface can be arranged in multiple configurations including, but not limited to, two host computers connected to a single interface in full bus mode, two interfaces in full or split bus mode and two host computers with each interface connected to an associated host computer, and two interfaces in full or split bus mode and four host computers.

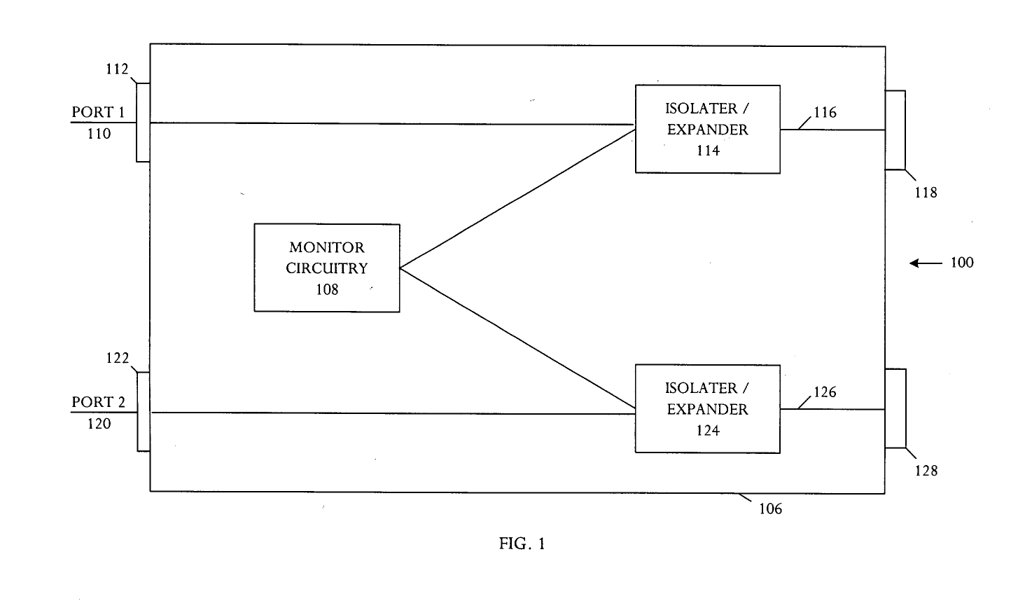

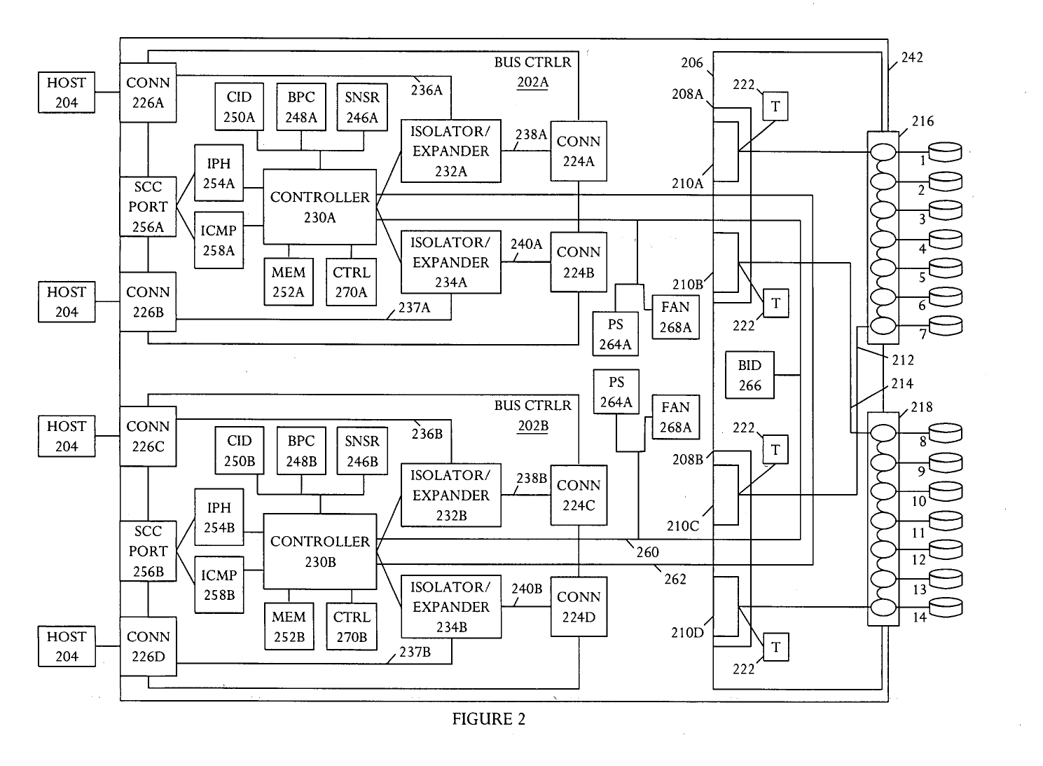

Referring to FIG. 1, a schematic block diagram illustrates an embodiment of a bus architecture 100. In an specific example the bus architecture 100 can be a high speed bus architecture such as a Small Computer Systems Interface (SCSI) bus architecture. In a specific embodiment, the bus architecture 100 can be used in a hot swappable high-speed dual port bus interface card such as a Small Computer Systems Interface (SCSI) bus interface card shown as an enclosure and bus controller card in FIG. 2.

The bus architecture 100 comprises two ports 110 and 120 that are connected to respective connectors 112 and 122 and coupled to respective gateway isolator/expanders 114 and 124. The isolator/expanders 114 and 124 perform timer and repeater functions in the signal path. The isolator/expanders 114 and 124 enable a user to expand the bus capabilities. For example, an expander can mix single-ended and differential interfaces, extend cable lengths, isolate bus segments, increase the number of peripherals the system can access, and/or dynamically reconfigure bus components. The dual port bus interface can be arranged in multiple configurations including, but not limited to, two host computers connected to a single interface in full bus mode, two interfaces in full or split bus mode and two host computers with each interface connected to an associated host computer, and two interfaces in full or split bus mode and four host computers.

In an illustrative embodiment, connectors 112 and 122 can be Very High Density Cable Interconnect (VHDCI) connectors. The gateway isolator/expanders 114 and 124 coupled to backplane connectors 118 and 128 via stubs 116 and 126 to backplane SCSI buses. Monitor circuitry 108 couples to each gateway isolator/expander 114 and 124.

The bus architecture 100 enables bridging of high speed signals across two separate SCSI buses on the backplane or enables high speed signals from the two VHDCI connectors 112 and 122 to attach to only one of the SCSI buses on the backplane. Without bridging, two interfaces would be needed to attach to each SCSI bus on the backplane, limiting possible configurations.

The bus architecture 100 enables improvement of signal integrity through impedance and length matching, further enabling high speed Low Voltage Differential (LVD) signal flow on a bus interface card 106. In an illustrative embodiment, High Voltage Differential (HVD) or Single-ended SCSI signal flow is not supported.

In a specific embodiment, the SCSI bus connecting the VHDCI connectors 112 and 122, the monitor circuitry 108, and the isolator/expanders 114 and 124 are length and impedance matched across routing layers in a bus interface card 106. Interconnect lines to the VHDCI connectors 112 and 122, monitor circuitry 108, and isolator/expanders 114 and 124 are minimized and can be eliminated by passing signal lines through integrated chip connector pins rather than supplying interconnect traces to the stubs.

SCSI bus stubs 116 and 126 to backplane connectors 118 and 128 can be impedance and length matched. In a specific example, stubs 116 and 126 are reduced to minimum length and configured as point-to-point connections between the backplane connectors 118 and 128 and the isolator/expanders 114 and 124, and stubs are not shared with other devices. To conserve space on an interface 106, interconnect traces can be spread over surface and internal printed circuit board (PCB) layers. Trace widths are varied to match impedance. Trace lengths are varied to match electrical lengths.

In the illustrative embodiment, the isolator/expanders 114 and 124 perform a bridging function so that a dedicated bridge circuit or chip can be omitted. Status of the isolator/expanders 114 and 124 depends on enclosure configuration, position of the isolator/expanders 114 and 124 in the enclosure, and interface card status of the bus interface card 106 and an associated peer card. The bridging function becomes active when two isolator/expanders 114 and 124 on the same bus interface card 106 are enabled.

The SCSI bus architecture 100 supports high-speed signals at least partly through usage of simple control functionality between SCSI bus control interface cards. Control functions manage operability on the basis of card status, isolater/expander status, VHDCI connector status, and enclosure element control status including fan speed, DIP switch configuration, disk LED status, enclosure LED status, and monitor circuitry status.

The isolator/expanders 114 and 124 are controlled to ensure proper enclosure configuration and avoid data corruption and bus contention. Expander control for the illustrative bus architecture 100 depends on state of the interface card, position of the card, and enclosure configuration.

TABLE I depicts states of a SCSI controller card for usage in expander

TABLE 1

| | Simplified Expander | |
|---|---|---|
| Interface States | Status | Assignment Bits |
| Primary | Primary | 11 |
| Secondary | Secondary | 10 |
| Pseudo-Fault Primary | Pseudo | 01 |
| Pseudo-Fault Secondary | | |
| Pseudo-Primary | | |
| Pseudo-Secondary | | |
| Fault | Fault | 00 |

In TABLE I, pseudo states can be merged because both expanders are disabled when the system is in any of the states. The corresponding and resulting truth table for controlling expanders is shown in TABLE II.

TABLE II

| | | Enclosure | | High | Low |
|---|---|---|---|---|---|
| | Card | Configuration | Card Slot | Expander | Expander |
| | Status | BRDG_EN | #SLOT A | EH_WS_EN | EL_WS_EN |
| Fault | 00 | 0 (Split Bus) | 0 (Slot A) | 0 (Disabled) | 0 (Disabled) |
| | 00 | 0 | 1 (Slot B) | 0 | 0 |
| | 00 | 1 (Full Bus) | 0 | 0 | 0 |
| | 00 | 1 | 1 | 0 | 0 |
| Pseudo | 01 | 0 | 0 | 0 | 0 |
| | 01 | 0 | 1 | 0 | 0 |
| | 01 | 1 | 0 | 0 | 0 |
| | 01 | 1 | 1 | 0 | 0 |
| Secondary | 10 | 0 | 0 | 1 (Enabled) | 0 |
| | 10 | 0 | 1 | 0 | 1 (Enabled) |
| | 10 | 1 | 0 | 0 | 1 |
| | 10 | 1 | 1 | 1 | 0 |
| Primary | 11 | 0 | 0 | 1 | 0 |
| | 11 | 0 | 1 | 0 | 1 |
| | 11 | 1 | 0 | 1 | 1 |
| | 11 | 1 | 1 | 1 | 1 |

The resulting equations are:

EH_{—}WS_{—}EN=(Primary(BRDG_{—}EN+!BRDG_{—}EN*!#SLOT_{—}A)+Secondary(BRDG_{—}EN*#SLOT_{—}A+! BRDG_{—}EN*#SLOT_{—}A))*!Pseudo*!Fault

EL_{—}WS_{—}EN=(Primary(BRDG_{—}EN+#SLOT_{—}A)+Secondary(BRDG_{—}EN*!#SLOT_{—}A+!BRDG_{—}EN*#SLOT_{—}A))*!Pseudo*!Fault

Generally, the interface card (BCC) in slot A aligns with the expander connecting to the high addresses. However, if the enclosure is in full bus mode and the interface card in slot A is secondary the expander associated with the low addresses is enabled. The same relationships and configurations apply to an interface in the B slot. The B slot expander is usually associated with low addresses although for an enclosure in the full bus mode and a card with secondary status, the expander associated with the high addresses is enabled. Accordingly, control elements, such as a field programmable gate array (FPGA) can determine how the enclosure is configured and can use the information to determine how long to hold SCSI bus resets.

If an interface card is transitioning from secondary status to primary status and the enclosure is in full bus mode, the SCSI bus reset is to be held until the secondary card has deactivated both expanders. Otherwise, the SCSI bus reset is only reset for approximately 100 μS.

The isolator/expanders 114 and 124 are controlled to perform multiple functions. The interface card resets or disables isolator/expanders 114 and 124 to isolate the interface card 106 from the backplane so that the interface drives neither an external Primary signal nor an internal Primary signal. The interface card 106 maintains the front end data bus in a reset condition while releasing the back end after disabling the isolator/expanders 114 and 124. In a specific embodiment, the interface can cease driving a signal indicating that the interface is Primary, for example allowing #PRI_BCC to be pulled high, if possible. The isolator/expanders 114 and 124 are controlled to enable and disable bridge functionality without utilizing a circuit or component that is dedicated to bridge functionality.

The isolator/expanders 114 and 124 are controlled to avoid bus contention and possible data corruption. The expander control technique enables control elements in the interface 106 to determine how the enclosure is configured without monitoring configuration switches.

FIG. 2 is a block diagram showing a data communication system 200 for high speed data transfer between peripheral devices 1 through 14 and host computers 204 via BCCs 202A and 202B. Bus controller cards (BCCs) 202A and 202B are configured to transfer data at very high speeds, such as 160, 320, or more, megabytes per second. One BCC 202A or 202B can assume data transfer responsibilities of the other BCC when the other BCC is removed or is disabled by a fault/error condition. BCCs 202A and 202B include monitoring circuitry to detect events such as removal or insertion of the other BCC, and monitor operating status of the other BCC. When a BCC is inserted but has a fault condition, the other BCC can reset the faulted BCC. Under various situations BCCs 202A, 202B can include one or more other logic components that hold the reset signal and prevent lost or corrupted data transfers until system components are configured and ready for operation.

BCCs 202A and 202B interface with backplane 206, typically a printed circuit board (PCB) that is installed within other assemblies such as a chassis for housing peripheral devices 1 through 14, as well as BCCs 202A, 202B. In some embodiments, backplane 206 includes interface slots 208A, 208B with connector portions 210A, 210B, and 210C, 210D, respectively, that electrically connect BCCs 202A and 202B to backplane 206.

Interface slots 208A and 208B, also called bus controller slots 208A and 208B, are electrically connected and configured to interact and communicate with components included on BCCs 202A, 202B and backplane components. Generally, when multiple peripheral devices and controller cards are included in a system, various actions or events can affect system configuration. Controllers 230A and 230B can include logic that configures status of BCCs 202A and 202B depending on the type of action or event. The actions or events can include: attaching or removing one or more peripheral devices from system 200; attaching or removing one or more controller cards from system 200; removing or attaching a cable to backplane 206; and powering system 200.

BCCs 202A and 202B can be fabricated as single or multi-layered printed circuit board(s), with layers designed to accommodate specified impedance for connections to host computers 204 and backplane 206. In some embodiments, BCCs 202A and 202B handle only differential signals, such as LVD signals, eliminating support for single ended (SE) signals and simplifying impedance matching considerations. Some embodiments allow data path signal traces on either internal layers or the external layers of the PCB, but not both, to avoid speed differences in the data signals. Data signal trace width on the BCC PCBs can be varied to match impedance at host connector portions 226A through 226D, and at backplane connector portions 224A through 224D.

Buses A 212 and B 214 on backplane 206 enable data communication between peripheral devices 1 through 14 and host computing systems 204, functionally coupled to backplane 206 via BCCs 202A, 202B. BCCs 202A and 202B, as well as A and B buses 212 and 214, can communicate using the SCSI communication or other protocol. In some embodiments, buses 212 and 214 are low voltage differential (LVD) Ultra-4 or Ultra-320 SCSI buses, for example. Alternatively, system 200 may include other types of communication interfaces and operate in accordance with other communication protocols.

A bus 212 and B bus 214 include a plurality of ports 216 and 218 respectively. Ports 216 and 218 can each have the same physical configuration. Peripheral devices 1 through 14 such as disk drives or other devices are adapted to communicate with ports 216, 218. Arrangement, type, and number of ports 216, 218 between buses 212, 214 may be configured in other arrangements and are not limited to the embodiment illustrated in FIG. 2.

In some embodiments, connector portions 210A and 210C are electrically connected to A bus 212, and connector portions 210B and 210D are electrically connected to B bus 214. Connector portions 210A and 210B are physically and electrically configured to receive a first bus controller card, such as BCC 202A. Connector portions 210C and 210D are physically and electrically configured to receive a second bus controller card such as BCC 202B.

BCCs 202A and 202B respectively include transceivers that can convert voltage levels of differential signals to the voltage level of signals utilized on a single-ended bus, or can only recondition and resend the same signal levels. Terminators 222 can be connected to backplane connectors 210A through 210D to signal the terminal end of buses 212, 214. To work properly, terminators 222 use “term power” from bus 212 or 214. Term power is typically supplied by the host adapter and by the other devices on bus 212 and/or 214 or, in this case, power is supplied by a local power supply. In one embodiment, terminators 222 can be model number DS2108 terminators from Dallas Semiconductor.

In one or more embodiments, BCCs 202A, 202B include connector portions 224A through 224D, which are physically and electrically adapted to mate with backplane connector portions 210A through 210D. Backplane connector portions 210A through 210D and connector portions 224A through 224D are most appropriately impedance controlled connectors designed for high-speed digital signals. In one embodiment, connector portions 224A through 224D are 120 pin count Methode/Teradyne connectors.

In some embodiments, one of BCC 202A or 202B assumes primary status and acts as a central control logic unit for managing configuration of system components. With two or more BCCs, system 200 can be implemented to give primary status to a BCC in a predesignated slot. The primary and non-primary BCCs are substantially physically and electrically the same, with “primary” and “non-primary” denoting functions of the bus controller cards rather than unique physical configurations. Other schemes for designating primary and non-primary BCCs can be utilized.

In some embodiments, the primary BCC is responsible for configuring buses 212, 214, as well as performing other services such as bus addressing. The non-primary BCC is not responsible for configuring buses 212, 214, and responds to bus operation commands from the primary card rather than initiating commands independently. In other embodiments, both primary and non-primary BCCs can configure buses 212, 214, initiate, and respond to bus operation commands.

BCCs 202A and 202B can be hot-swapped, the ability to remove and replace BCC 202A and/or 202B without interrupting communication system operations. The interface architecture of communication system 200 allows BCC 202A to monitor the status of BCC 202B, and vice versa. In some circumstances, such as hot-swapping, BCCs 202A and/or 202B perform fail-over activities for robust system performance. For example, when BCC 202A or 202B is removed or replaced, is not fully connected, or experiences a fault condition, the other BCC performs functions such as determining whether to change primary or non-primary status, setting signals to activate fault indications, and resetting BCC 202A or 202B. For systems with more than two BCCs, the number and interconnections between buses on backplane 206 can vary accordingly.

Host connector portions 226A, 226B are electrically connected to BCC 202A. Similarly, host connector portions 226C, 226D are electrically connected to BCC 202B. Host connector portions 226A through 226D are adapted, respectively, for connection to a host device, such as a host computers 204. Host connector portions 226A through 226D receive voltage-differential input signals and transmit voltage-differential output signals. BCCs 202A and 202B can form an independent channel of communication between each host computer 204 and communication buses 212, 214 implemented on backplane 206. In some embodiments, host connector portions 226A through 226D are implemented with connector portions that conform to the Very High Density Cable Interconnect (VHDCI) connector standard. Other suitable connectors and connector standards can be used.

Card controllers 230A, 230B can be implemented with any suitable processing device, such as controller model number VSC205 from Vitesse Semiconductor Corporation in Camarillo, Calif. in combination with FPGA/PLDs that are used to monitor and react to time sensitive signals. Card controllers 230A, 230B execute instructions to control BCC 202A, 202B; communicate status information and data to host computers 204 via a data bus, such as a SCSI bus; and can also support diagnostic procedures for various components of system 200.

BCCs 202A and 202B can include isolators/expanders 232A, 234A, and 232B, 234B, respectively, to isolate and retime data signals. Isolators/expanders 232A, 234A can isolate A and B buses 212 and 214 from monitor circuitry on BCC 202A, while isolators/expanders 232B, 234B can isolate A and B buses 212 and 214 from monitor circuitry on BCC 202B. Expander 232A communicates with backplane connector 224A, host connector portion 226A, and card controller 230A, while expander 234A communicates with backplane connector 224B, host connector portion 226B and card controller 230A. On BCC 202B, expander 232B communicates with backplane connector 224C, host connector portion 226B, and controller 230B, while expander 234B communicates with backplane connector 224D, host connector portion 226D and controller 230B.

Expanders 232A, 234A, 232B, and 234B support installation, removal, or exchange of peripherals while the system remains in operation. A controller or monitor that performs an isolation function monitors and protects host computers 204 and other devices by delaying the actual power up/down of the peripherals until an inactive time period is detected between bus cycles, preventing interruption of other bus activity. The isolation function also prevents power sequencing from generating signal noise that can corrupt data signals. In some embodiments, expanders 232A, 234A, and 232B, 234B are implemented in an integrated circuit from LSI Logic Corporation in Milpitas, Calif., such as part numbers SYM53C180 or SYM53C320, depending on the data transfer speed. Other suitable devices can be utilized. Expanders 232A, 234A, and 232B, 234B can be placed as close to backplane connector portions 224A through 224D as possible to minimize the length of data bus signal traces 238A, 240A, 238B, and 240B.

Impedance for the front end data path from host connector portions 226A and 226B to card controller 230A is designed to match a cable interface having a measurable coupled differential impedance, for example, of 135 ohms. Impedance for a back end data path from expanders 232A and 234A to backplane connector portions 224A and 224B typically differs from the front end data path impedance, and may only match a single-ended impedance, for example 67 ohms, for a decoupled differential impedance of 134 ohms.

In the illustrative embodiment, buses 212 and 214 are each divided into three segments on BCCs 202A and 202B, respectively. A first bus segment 236A is routed from host connector portion 226A to expander 232A to card controller 230A, to expander 234A, and then to host connector portion 226B. A second bus segment 238A originates from expander 232A to backplane connector portion 224A, and a third bus segment 240A originates from expander 234A to backplane connector portion 224B. BCC 202A can connect to buses 212, 214 on backplane 206 if both isolators/expanders 232A and 234A are activated, or connect to one bus on backplane 206 if only one expander 232A or 234A is activated. A similar data bus structure can be implemented on other BCCs, such as BCC 202B, shown with bus segments 236B, 238B, and 240B corresponding to bus segments 236A, 238A, and 240A on BCC 202A. BCCs 202A and 202B respectively can include transceivers to convert differential signal voltage levels to the voltage level of signals on buses 236A and 236B.

System 200 can operate in full bus or split bus mode. In full bus mode, all peripherals 1-14 can be accessed by the primary BCC and the Secondary BCC, if available. The non-primary BCC assumes Primary functionality in the event of Primary failure. In split bus mode, one BCC accesses data through A bus 212 while the other BCC accesses peripherals 1-14 through B bus 214. In some embodiments, a high and low address bank for each separate bus 216, 218 on backplane 206 can be utilized. In other embodiments, each slot 208A, 208B on backplane 206 is assigned an address to eliminate the need to route address control signals across backplane 206. In split bus mode, monitor circuitry utilizes an address on backplane 206 that is not utilized by any of peripherals 1 through 14. For example, SCSI bus typically allows addressing up to 15 peripheral devices. One of the 15 addresses can be reserved for use by the monitor circuitry on BCCs 202A, 202B to communicate operational and status parameters to Hosts 204. BCCs 202A and 202B communicate with each other over out of band serial buses such as general purpose serial I/O bus

For BCCs 202A and 202B connected to backplane 206, system 200 operates in full bus mode with the separate buses 212, 214 interconnected on backplane 206. The non-primary BCC does not receive commands directly from bus 212 or 214 since primary BCC sends bus commands to the non-primary BCC. Other addressing and command schemes may be suitable. Various configurations of host computers 204 and BCCs 202A, 202B can be included in system 200, such as:

two host computers 204 connected to a single BCC in full bus mode;

two BCCs in full or split bus mode and two host computers 204, with one of host computer 204 connected to one BCC, and the other host computer 204 connected to the other BCC; and

two BCCs in full or split bus mode and four host computers 204, as shown in FIG. 2.

In some examples, backplane 206 may be included in a Hewlett-Packard DS2300 disk enclosure and may be adapted to receive DS2300 bus controller cards. DS2300 controller cards use a low voltage differential (LVD) interface to buses 212 and 214.

System 200 has components for monitoring enclosure 242 and operating BCCs 202A and 202B. The system 200 includes card controllers 230A, 230B; sensors modules 246A, 246B; backplane controllers (BPCs) 248A, 248B; card identifier modules 250A, 250B; and backplane identifier module 266. The system 200 also includes flash memory 252A, 252B; serial communication connector port 256A, 256B, such as an RJ12 connector port; and interface protocol handlers such as RS-232 serial communication protocol handler 254A, 254B, and Internet Control Message Protocol handler 258A, 258B. The system monitors status and configuration of enclosure 242 and BCCs 202A, 202B; gives status information to card controllers 230A, 230B and to host computers 204; and controls configuration and status indicators. In some embodiments, monitor circuitry components on BCCs 202A, 202B communicate with card controllers 230A, 230B via a relatively low-speed system bus, such as an Inter-IC bus (12C). Other data communication infrastructures and protocols may be suitable.

Status information can be formatted using standardized data structures, such as SCSI Enclosure Services (SES) and SCSI Accessed Fault Tolerant Enclosure (SAF-TE) data structures. Messaging from enclosures that are compliant with SES and SAF-TE standards can be translated to audible and visible notifications on enclosure 242, such as status lights and alarms, to indicate failure of critical components. Enclosure 242 can have one or more switches, allowing an administrator to enable the SES, SAF-TE, or other monitor interface scheme.

Sensor modules 246A, 246B can monitor voltage, fan speed, temperature, and other parameters at BCCs 202A and 202B. One suitable set of sensor modules 246A, 246B is model number LM80, which is commercially available from National Semiconductor Corporation in Santa Clara, Calif. In some embodiments, Intelligent Platform Management Interface (IPMI) specification defines a standard interface protocol for sensor modules 246A and 246B. Other sensors specifications may be suitable.

Backplane controllers 248A, 248B interface with card controllers 230A, 230B, respectively, to give control information and report on system configuration. In some embodiments, backplane controllers 248A, 248B are implemented with backplane controller model number VSC055 from Vitesse Semiconductor Corporation in Camarillo, Calif. Other components for performing backplane controller functions may be suitable. Signals accessed by backplane controllers 248A, 248B can include disk drive detection, BCC primary or non-primary status, expander enable and disable, disk drive fault indicators, audible and visual enclosure or chassis indicators, and bus controller card fault detection. Other signals include bus reset control enable, power supply fan status, and others.

Card identifier modules 250A, 250B supply information, such as serial and product numbers of BCCs 202A and 202B to card controllers 230A, 230B. Backplane identifier module 266 also supplies backplane information such as serial and product number to card controllers 230A, 230B. In some embodiments, identifier modules 250A, 250B, and 266 are implemented with an electronically erasable programmable read only memory (EEPROM) and conform to Field Replaceable Unit Identifier (FRU-ID) standard. Field replaceable units (FRU) can be hot swappable and individually replaced by a field engineer. A FRU-Id code can be included in an error message or diagnostic output indicating the physical location of a system component such as a power supply or I/O port. Other identifier modules may be suitable.

RJ-12 connector 256A enables connection to a diagnostic port in card controller 230A, 230B to access troubleshooting information, download software and firmware instructions, and as an ICMP interface for test functions.

Monitor data buses 260 and 262 transmit data between card controllers 230A and 230B across backplane 206. Data exchanged between controllers 230A and 230B can include a periodic heartbeat signal from each controller 230A, 230B to the other to indicate the other is operational, a reset signal allowing reset of a faulted BCC by another BCC, and other data. If the heartbeat signal is lost in the primary BCC, the non-primary BCC assumes primary BCC functions. Operational status of power supply 264A and a cooling fan can also be transmitted periodically to controller 230A via bus 260. Similarly, bus 260 can transmit operational status of power supply 264B and the cooling fan to controller 230B. Card controllers 230A and 230B can share data that warns of monitoring degradation and potential failure of a component. Warnings and alerts can be issued by any suitable method such as indicator lights on enclosure 242, audible tones, and messages displayed on a system administrator's console. In some embodiments, buses 260 and 262 can be implemented with a relatively low-speed system bus, such as an Inter-IC bus (I2C). Other suitable data communication infrastructures and protocols can be utilized in addition to, or instead of, the I2C standard.

Panel switches and internal switches may be also included on enclosure 242 for BCCs 202A and 202B. The switches can be set in various configurations, such as split bus or full bus mode, to enable desired system functionality.

One or more logic units can be included on BCCs 202A and 202B, such as FPGA 254A, to perform time critical tasks. For example, FPGA 254A can generate reset signals and control enclosure indicators to inform of alert conditions and trigger processes to help prevent data loss or corruption. Conditions may include insertion or removal of a BCC in system 200; insertion or removal of a peripheral; imminent loss of power from power supply 264A or 264B; loss of term power; and cable removal from one of host connector portions 226A through 226D.

Instructions in FPGAs 254A, 254B can be updated by corresponding card controller 230A, 230B or other suitable devices. Card controllers 230A, 230B and FPGAs 254A, 254B can cross-monitor operating status and assert a fault indication on detection of non-operational status. In some embodiments, FPGAs 254A, 254B include instructions to perform one or more of functions including bus resets, miscellaneous status and control, and driving indicators. Bus resets may include reset on time critical conditions such as peripheral insertion and removal, second BCC insertion and removal, imminent loss of power, loss of termination power, and cable or terminator removal from a connector. Miscellaneous status and control includes time critical events such as expander reset generation and an indication of BCC full insertion. Non-time critical status and control includes driving the disks delayed start signal and monitoring BCC system clock and indicating clock failure with a board fault. Driving indicators include a peripheral fault indicator, a bus configuration (full or split bus) indicator, a term power available indicator, an SES indicator for monitoring the enclosure, SAF-TE indicator for enclosure monitoring, an enclosure power indicator, and an enclosure fault or FRU failure indicator.

A clock signal can be supplied by one or more of host computers 204 or generated by an oscillator implemented on BCCs 202A and 202B. The clock signal can be supplied to any component on BCCs 202A and 202B.

The illustrative BCCs 202A and 202B enhance BCC functionality by enabling high speed signal communication across separate buses 212, 214 on backplane 206. Alternatively, high speed signals from host connector portions 226A and 226B, or 226C and 226D, can be communicated across only one of buses 212, 214.

High speed data signal integrity can be optimized in illustrative BCC embodiments by matching impedance and length of the traces for data bus segments 236A, 238A, and 240A across one or more PCB routing layers. Trace width can be varied to match impedance and trace length varied to match electrical lengths, improving data transfer speed. Signal trace stubs to components on BCC 202A can be reduced or eliminated by connecting signal traces directly to components rather than by tee connections. Length of bus segments 238A and 240A can be reduced by positioning expanders 232A and 234A as close to backplane connector portions 224A and 224B as possible.

In some embodiments, two expanders 232A, 234A on the same BCC 202A can be enabled simultaneously, forming a controllable bridge connection between A bus 212 and B bus 214, eliminating the need for a dedicated bridge module.

Described logic modules and circuitry may be implemented using any suitable combination of hardware, software, and/or firmware, such as Field Programmable Gate Arrays (FPGAs), Application Specific Integrated Circuit (ASICs), or other suitable devices. A FPGA is a programmable logic device (PLD) with a high density of gates. An ASIC is a microprocessor that is custom designed for a specific application rather than a general-purpose microprocessor. Use of FPGAs and ASICs improves system performance in comparison to general-purpose CPUs, because logic chips are hardwired to perform a specific task and avoid the overhead of fetching and interpreting stored instructions. Logic modules can be independently implemented or included in one of the other system components such as controllers 230A and 230B. Other BCC components described as separate and discrete components may be combined to form larger or different integrated circuits or electrical assemblies, if desired.

Although the illustrative example describes a particular type of bus interface, specifically a High Speed Dual Ported SCSI Bus Interface, the claimed elements and actions may be utilized in other bus interface applications defined under other standards. Furthermore, the particular control and monitoring devices and components may be replaced by other elements that are capable of performing the illustrative functions. For example, alternative types of controllers may include processors, digital signal processors, state machines, field programmable gate arrays, programmable logic devices, discrete circuitry, and the like. Program elements may be supplied by various software, firmware, and hardware implementations, supplied by various suitable media including physical and virtual media, such as magnetic media, transmitted signals, and the like.

What is claimed is:

1. An expander controller for a dual ported bus interface comprising:
a controller coupled to the dual ported bus interface, the dual ported bus interface having first and second front end ports capable of connecting to host bus adapters, first and second isolator/expanders coupled to the first and second front end ports, first and second backplane connectors for insertion into a selected slot of first and second slots and coupling to one or more buses on the backplane, and interconnections for coupling signals from the first and second front end ports through the isolator/expanders to the backplane buses; and
a programmable code executable on the controller and further comprising:
a programmable code that detects interface status, bus configuration, and selected slot; and
a programmable code that controls operations of the isolator/expanders based on the detected interface status, bus configuration, and selected slot.

2. The expander controller according to claim 1 further comprising:
a programmable code executable on the controller that selectively enables and disables the isolator/expanders based on the detected interface status, bus configuration, and selected slot.

3. The expander controller according to claim 1 further comprising:
a programmable code executable on the controller that detects the interface status from among primary, secondary, pseudo, and fault states.

4. The expander controller according to claim 1 further comprising:
a programmable code executable on the controller that detects the bus configuration from between split bus and full bus configurations.

5. The expander controller according to claim 1 further comprising:
a programmable code executable on the controller that enables a high expander of the first and second isolator/expanders in conditions of:
the interface status is primary state and the bus configuration is full bus;
the interface status is primary state, the bus configuration is split bus, and the second slot is selected;
the interface status is secondary state, the bus configuration is full bus, and the first slot is selected; or
the interface status is secondary state, the bus configuration is split bus, and the second slot is selected; and
the programmable code otherwise disables the high expander.

6. The expander controller according to claim 1 further comprising:
a programmable code executable on the controller that enables a low expander of the first and second isolator/expanders in conditions of:
the interface status is primary state and the bus configuration is full bus;
the interface status is primary state and the first slot is selected;
the interface status is secondary state, the bus configuration is full bus, and the second slot is selected; or
the interface status is secondary state, the bus configuration is split bus, and the first slot is selected; and
the programmable code otherwise disables the low expander.

7. The expander controller according to claim 1 further comprising:
a programmable code that controls operations of the isolator/expanders independent of programmable configuration switch settings.

8. A dual ported bus interface comprising:
first and second front end ports capable of connecting to host bus adapters;
first and second isolator/expanders coupled to the first and second front end ports;
first and second backplane connectors for insertion into a selected slot of first and second slots and coupling to one or more buses on the backplane;
a controller coupled to the first and second isolator/expanders for communicating signals from the first and second front end ports through the isolator/expanders to the backplane buses with bridging, the controller being capable of detecting interface status, bus configuration, and selected slot, and capable of controlling operations of the isolator/expanders based, on the detected interface status, bus configuration, and selected slot.

9. The bus interface according to claim 8 wherein:
the controller selectively enables and disables the isolator/expanders based on the detected interface status, bus configuration, and selected slot.

10. The bus interface according to claim 8 wherein:
the controller detects the interface status from among primary, secondary, pseudo, and fault states.

11. The bus interface according to claim 8 wherein:
the controller detects the bus configuration from between split bus and full bus configurations.

12. The bus interface according to claim 8 wherein:
the controller enables a high expander of the first and second isolator/expanders in conditions of:
the interface status is primary state and the bus configuration is full bus;
the interface status is primary state, the bus configuration is split bus, and the second slot is selected;
the interface status is secondary state, the bus configuration is full bus, and the first slot is selected; or
the interface status is secondary state, the bus configuration is split bus, and the second slot is selected; and
the controller otherwise disables the high expander.

13. The bus interface according to claim 8 wherein:
the controller enables a low expander of the first and second isolator/expanders in conditions of:
the interface status is primary state and the bus configuration is full bus;
the interface status is primary state and the first slot is selected;
the interface status is secondary state, the bus configuration is full bus, and the second slot is selected; or
the interface status is secondary state, the bus configuration is split bus, and the first slot is selected; and
the controller otherwise disables the low expander.

14. The bus interface according to claim 8 wherein:
the controller controls operations of the isolator/expanders independent of programmable configuration switch settings.

15. A method of controlling operations of isolator/expanders in a dual ported bus interface comprising:
detecting status of the bus interface from among a primary state, a secondary state, a pseudo state, and a fault state;
determining a configuration of the bus interface between a full bus configuration and a split bus configuration;
determining a slot into which the bus interface is inserted from between a first slot and a second slot; and
controlling operations of the isolator/expanders based on the detected interface status, the bus configuration, and the selected slot.

16. The method according to claim 15 further comprising:
enabling a high expander of the first and second isolator/expanders in conditions of:
the interface status is primary state and the bus configuration is full bus;
the interface status is primary state, the bus configuration is split bus, and the second slot is selected;
the interface status is secondary state, the bus configuration is full bus, and the first slot is selected; or
the interface status is secondary state, the bus configuration is split bus, and the second slot is selected; and
otherwise disabling the high expander.

17. The method according to claim 15 further comprising:
enabling a low expander of the first and second isolator/expanders in conditions of:
the interface status is primary state and the bus configuration is full bus;
the interface status is primary state and the first slot is selected;
the interface status is secondary state, the bus configuration is full bus, and the second slot is selected; or
the interface status is secondary state, the bus configuration is split bus, and the first slot is selected; and
otherwise disabling the low expander.

18. The method according to claim 15 further comprising:
controlling operations of the isolator/expanders independent of programmable configuration switch settings.

19. The method according to claim 15 further comprising:
selectively operating the isolator/expanders in the split bus mode or the full bus mode.

20. A dual ported bus interface comprising:
means for connecting to host bus adapters;
means coupled to the connecting means for coupling to one or more buses on the backplane;
means for interconnecting signals from the first and second front end ports through to the backplane buses, the signal interconnecting means further comprising means for bridging between the first and second isolator/expanders;
means for detecting status of the bus interface from among a primary state, a secondary state, a pseudo state, and a fault state;
means for determining a configuration of the bus interface between a full bus configuration and a split bus configuration;
means for determining a slot into which the bus interface is inserted from between a first slot and a second slot; and
means for controlling operations of the isolator/expanders based on the detected interface status, the bus configuration, and the selected slot.
